(19) United States
(12) Patent Application Publication
(10) Pub. No.: US 2023/0250794 A1
(43) Pub. Date: Aug. 10, 2023

(54) BUOYANT ENERGY CONVERSION SYSTEM: HARNESSING THE POWER OF WATER AND AIR FOR CLEAN ENERGY PRODUCTION

(71) Applicant: Jack Coplen, Folsom, CA (US)

(72) Inventor: Jack Coplen, Folsom, CA (US)

(21) Appl. No.: 18/134,572

(22) Filed: Apr. 14, 2023

(51) Int. Cl. F03B 17/02

(52) U.S. Cl. CPC F03B 17/025

(57) ABSTRACT

The present invention describes a system for capturing and utilizing any type of air pressure to generate a reciprocal motion that drives a shaft in a single direction. The system is designed with the ability to accurately regulate pressure levels within each chamber and respond quickly to changes in pressure. The system includes a pressure gauge and pointer that allow for precise pressure regulation, as well as safety features such as holes and a capped peg to prevent pressure buildup and ensure safe operation. The invention is designed to be simple and cost-effective, making it a versatile and adaptable solution for a range of industrial and consumer applications. the described invention represents a significant advancement in the field of air pressure utilization and control, offering a reliable and efficient solution for a range of needs.

### FIELD OF THE INVENTION

The present invention generally relates to energy conversion system. More specifically, the present invention discloses an air pressure technology that can convert any form of air pressure, whether positive or negative, into a reciprocating motion. This motion is then cleverly transferred through a complex mechanism, ultimately resulting in the turning of a shaft in a single direction. This remarkable innovation has the potential to revolutionize the way we harness and utilize air pressure, offering a highly efficient and versatile solution to power a range of machinery and devices.

### BACKGROUND

Air pressure has long been used to power machinery and engines, with positive pressure commonly used in engines such as those in combustion and jet propulsion systems, while negative pressure or vacuum is used in applications such as suction systems and vacuum pumps. However, traditional mechanisms for converting air pressure into mechanical motion have limitations in terms of efficiency and versatility.

Existing solutions for converting air pressure into motion include piston-driven systems, which rely on the reciprocating motion of a piston to generate mechanical energy, and turbine-based systems, which use the rotational motion of a turbine to generate power. While these systems are effective in certain applications, they are limited in terms of their ability to operate efficiently across a range of pressure differentials and to convert both positive and negative pressure into mechanical motion. Furthermore, many existing air pressure systems require complex control mechanisms and expensive components, making them unsuitable for use in certain applications or in resource-constrained environments.

The presented invention aims to address these limitations by offering a more efficient and versatile method for converting air pressure into mechanical motion. By utilizing a reciprocal motion mechanism, the invention can effectively harness the energy of both positive and negative air pressure, resulting in improved efficiency and performance. In addition, the invention is designed to be simple and low-cost, with a minimal number of components and straightforward control mechanisms. This makes it suitable for use in a wide range of applications, from industrial machinery to consumer appliances and beyond. Overall, the presented invention offers a significant improvement over existing solutions for converting air pressure into mechanical motion, with potential benefits for a range of industries and applications.

### SUMMARY

It will be understood that this disclosure is not limited to the systems and methodologies particularly described herein, as there can be multiple possible embodiments of the present disclosure which are not expressly illustrated in the present disclosure. It is also to be understood that the terminology used in the description is to describe one or more versions or embodiments that are particular to the present invention only and is not intended to limit the scope of the present disclosure.

The present invention discloses air pressure technology, bringing with it the ability to harness the power of both positive and negative air pressure. With this revolutionary invention, any type of air pressure can be transformed into a reciprocal motion, which is then transferred through a sophisticated mechanism and ultimately translated into a single-directional turning motion of a sturdy and reliable shaft. This invention offers the flexibility and versatility to operate across a broad range of air pressure differentials, without sacrificing performance or energy efficiency.

Using the unique reciprocal motion mechanism, the invention captures the energy from the air pressure and converts it into powerful mechanical energy that is directed towards the shaft. This highly efficient process ensures that every bit of energy is utilized to create a single-directional turning motion that can be used to power a wide variety of machinery and appliances.

In short, this invention represents a significant breakthrough in air pressure technology, offering a flexible, efficient, and powerful solution to the challenges faced by traditional air pressure systems. With its ability to harness any type of air pressure and convert it into a single-directional turning motion, the possibilities for its application are endless, from industrial machinery to everyday appliances.

The present invention describes an innovative system that can capture and utilizing any type of air pressure to generate a reciprocal motion that drives a shaft in a single direction. The system is comprised of two chambers, each with a bottle that is moved either upward or downward by the air pressure within the chamber. The air flows through a series of valves, check valves, and pipes to move from one chamber to the other and create a cyclical process of air movement.

The system also includes a pressure gauge that is attached to each chamber and is designed to indicate any large pressure spikes or imbalances in pressure. The pressure gauge is connected to a pointer, which can indicate the level of pressure within each chamber. The pressure gauge and pointer are designed to work equally for either chamber, ensuring that any imbalances in pressure are quickly detected and addressed.

Overall, the system described in this patent application represents a significant advancement in the field of air pressure utilization and control, offering a reliable and efficient solution for a range of industrial and consumer applications. With its innovative design and ability to carefully regulate pressure within each chamber, this invention has the potential to revolutionize the way air pressure is utilized and harnessed in a variety of different contexts.

Additionally, the system includes a peg that is attached to a straw within each chamber, creating an airtight seal that allows air to be sucked in or released through strategically placed holes or the capped end of the peg. These features ensure that the pressure within each chamber is precisely regulated, and that the system can respond to changes in pressure quickly and effectively.

The above-described features and other advantages realized through the techniques of the present disclosure will be better appreciated and understood with reference to the following detailed description and drawings. Additional features and advantages are realized through the techniques of the present invention as described below.

### BRIEF DESCRIPTION OF ACCOMPANYING DRAWINGS

FIG. 1a is a diagram that shows a side perspective view of an arrangement for capturing buoyant power, according to an exemplary embodiment of the present invention.

FIG. 1b is a diagram that shows a top view of the arrangement for capturing buoyant power, according to an exemplary embodiment of the present invention.

FIGS. 1c and 1d illustrate a front view of the buoyant power capturing arrangement for illustrating its operation, according to an exemplary embodiment of the present invention.

FIG. 1e is a diagram that shows an air gauge for chamber, according to an exemplary embodiment of the present invention.

Further areas of applicability of the present invention will become apparent from the detailed description provided hereinafter. It should be further understood that the detailed description of exemplary embodiments is intended for illustration purposes only and is, therefore, not intended to necessarily limit the scope of the present invention.

### DETAILED DESCRIPTION

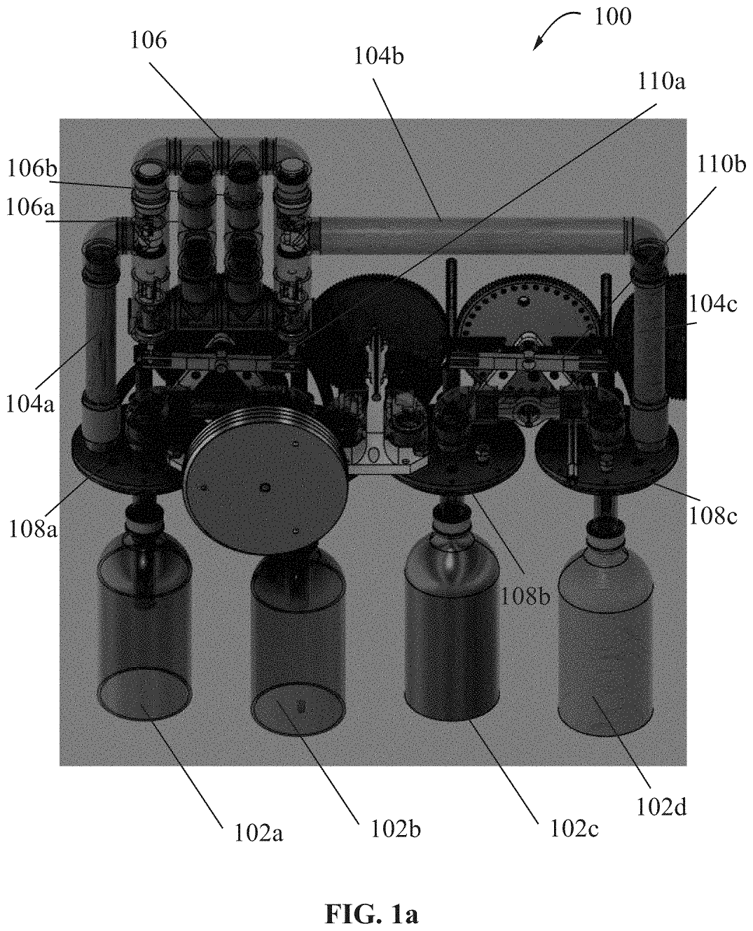

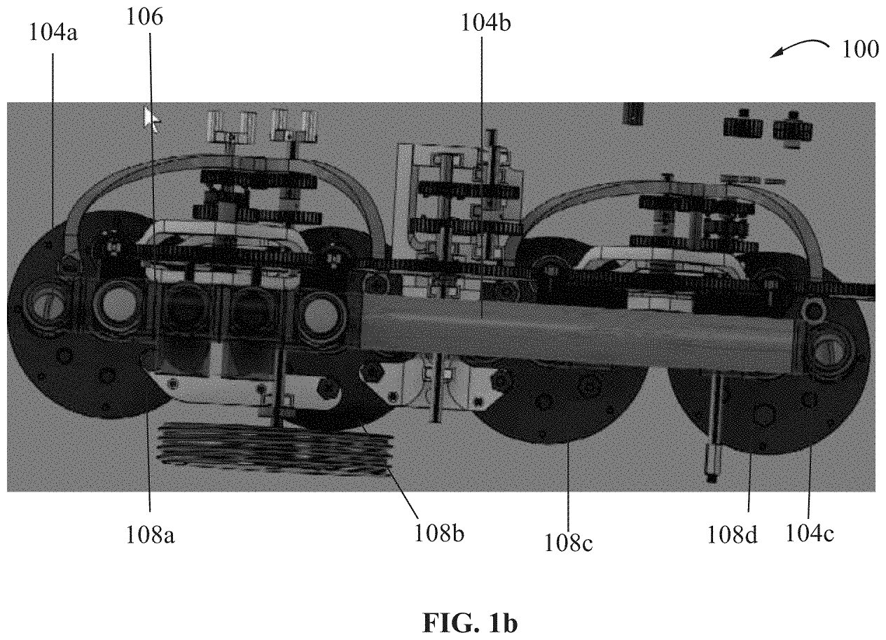

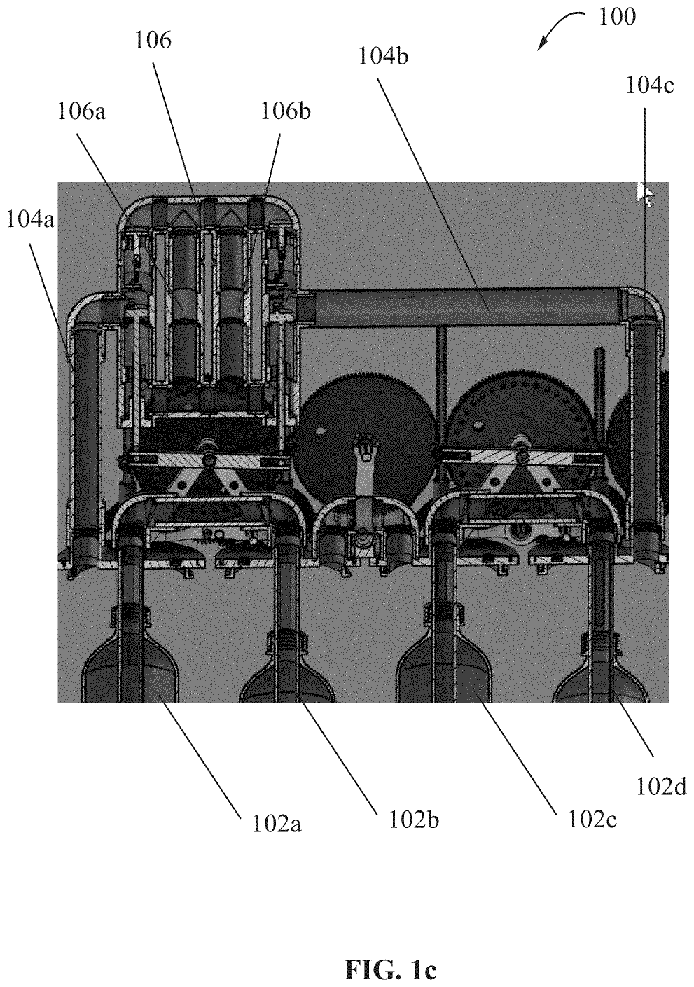

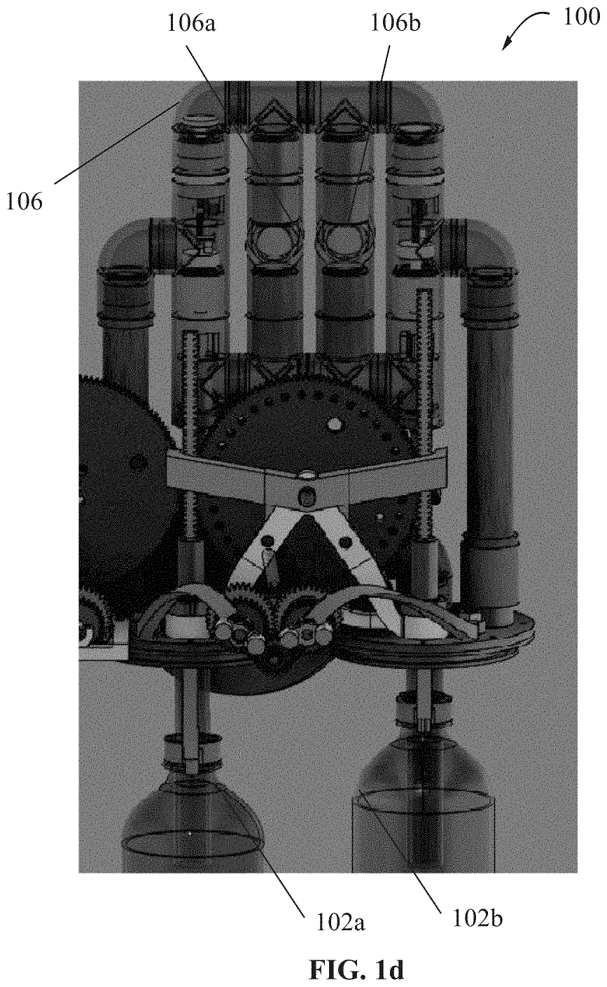

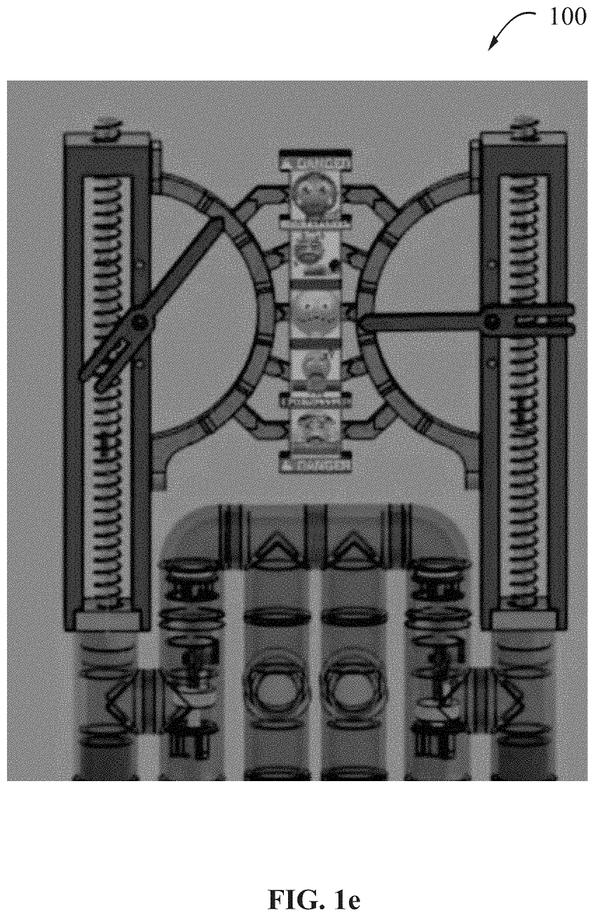

The present invention relates generally to mechanics, and more specifically, to air pressure technology that can convert any form of air pressure, whether positive or negative, into a reciprocating motion. This motion is then cleverly transferred through a complex mechanism, ultimately resulting in the turning of a shaft in a single direction. Specific details of certain embodiments of the present invention are outlined in the following description, in conjunction with FIGS. 1a-1e, to provide the understanding of various embodiments. The present invention may have additional embodiments, may be practiced without one or more of the details described for any embodiment, or may have any detail described for one embodiment practiced with any other detail described for another embodiment.

Throughout the specification and claims, the following terms take the meanings explicitly associated herein, unless the context clearly dictates otherwise. The phrase “in an embodiment” or “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” may include singular or plural references. The meaning of “in” includes “in” and “on.”

The following is a description of illustrative embodiments that when taken in conjunction with the following drawings will demonstrate the above noted features and advantages, as well as further ones. In the description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

Referring to FIGS. 1a, 1b, 1c, 1d, and 1e, there is shown a diagram 100 which illustrates a side perspective view of an arrangement for capturing buoyant power, according to an exemplary embodiment of the present invention. The arrangement shows many components such as four bottles 102a, 102b, 102c, and 102d. The arrangement further shows pipes 104a, 104b, and 104c. The arrangement further shows another pipe arrangement 106 as shown. The arrangement further shows valves 108a, 108b, 108c, and 108d. The arrangement further includes gears and levers. The connection or integration of various components has been shown in the figures (such as in FIGS. 1a, 1b, 1c, 1d, and 1e) but should not be construed as limiting to the scope of the present invention.

The present invention describes a unique air flow system that involves the entry of air through one of the centrally positioned pipes 106a and 106b. The air then progresses upwards, passing through the top check valve, which ensures that the air can only move in one direction. Once through the check valve, the air flows through the only open valve, situated on the left, and into the designated chamber. The system is comprised of one or more central pipes (such as the centrally positioned pipes 106a and 106b) which serves as the entry point for the air, a top check valve that ensures one-directional flow, and a control valve that regulates the flow of air into the chamber. The air enters the system through one of the centrally positioned pipes 106a and 106b and is directed upwards towards the top check valve. The top check valve ensures that air can only flow in one direction, preventing any backflow or loss of pressure. The air then flows through the only open control valve, located on the left side of the system, and into the designated chamber. The control valve is designed to regulate the flow of air into the chamber, allowing for precise control over the amount of air that enters the system. This precise control over air flow is essential for maximizing the efficiency of the system and ensuring that the air pressure is converted into mechanical motion with the highest possible level of accuracy. This system has been specifically designed to maximize the efficiency and effectiveness of air flow, while also ensuring that the air moves in the intended direction, as dictated by the check valve. By carefully controlling the flow of air through the system, the described invention can harness the energy of air pressure and convert it into mechanical motion with a high degree of accuracy and reliability.

The unique air flow system further employs a two or four bottle configuration (as shown by the bottles 102a, 102b, 102c, or 102d or any combination thereof) to convert the energy of air pressure into mechanical motion. However, it should be understood unique airflow system may employ any other number of bottles, and the two or four-bottle configuration as shown should just be considered merely exemplary. The system involves the use of a pipe to direct airflow into the first bottle, which causes the bottle to move downward as the air is displaced by the incoming air. Simultaneously, the air pressure inside the bottle is reduced as the air flows through the pipe and into the second bottle, causing it to become buoyant and move upward. As the air continues to flow through the pipe, the pressure in the first bottle decreases, causing it to fall downward. The motion of the falling bottle generates mechanical energy that can be harnessed to power a range of machinery and devices. Meanwhile, the second bottle, which is now filled with air, becomes buoyant and moves upward, providing a counterbalancing force to the falling first bottle. The system described in this patent application represents a significant advancement in air pressure technology, offering a sophisticated and efficient solution for a wide range of industrial and consumer applications. By utilizing a two-bottle configuration to carefully control the flow of air and convert air pressure into mechanical motion, this system has the potential to revolutionize the way air pressure is harnessed and utilized in a variety of different contexts. The two or four bottle configuration of the system ensures that the process is self-sustaining, with the motion of one bottle counterbalanced by the movement of the other. This makes the system highly efficient and effective, with the potential to be used in a wide range of applications where a reliable and efficient source of mechanical motion is required.

The unique air flow system further involves the use of two pipes and a check valve to control the flow of air and convert air pressure into mechanical motion. In this system, the air is initially directed into one of the pipes and then flows through the system before exiting through the other pipe. After entering the system, the air is directed through the first pipe and then flows through a series of mechanisms before being directed back up through the other pipe. The air then encounters the only open valve in the system, which is located at the bottom, allowing it to pass through and enter the check valve. The check valve is designed to ensure that the air can only flow in one direction, preventing any backflow or loss of pressure. Once through the check valve, the air continues to flow through the system, ultimately exiting through the other pipe. The use of two pipes and a check valve in this system ensures that the process is highly efficient and reliable, with minimal loss of energy or pressure. This makes the system ideal for use in a range of applications, from industrial machinery to consumer appliances, where precise control over air flow and efficient conversion of air pressure is essential.

The present invention further describes an innovative system for controlling the flow of air pressure that involves a gear mechanism, racks, and valves. In this system, the racks 110a and/or 110b are connected to the bottles (102a and 102b and/or 102c and 102d) that contain the air pressure, and as the racks move, they cause the gear to turn. The turning of the gear, in turn, causes an orange lever to flip, which triggers the reversal of the valves. This mechanism ensures that the flow of air pressure is controlled in a highly efficient and reliable manner, with the valves switching seamlessly and precisely according to the movements of the racks and gear.

The unique air flow system further involves a cyclic process of air movement to generate mechanical motion. In this system, the air initially enters the first chamber and causes the bottle to move downward as the air is displaced by the incoming air. Once the air has entered the first chamber and caused the bottle to move downward, it then proceeds through the other side of the system and enters the second chamber. The air pressure in the second chamber then increases, causing the bottle to move upward and continue the cyclic process of air movement. The cyclic process of air movement in this system ensures that the process is self-sustaining, with the motion of one bottle counterbalanced by the movement of the other. This makes the system highly efficient and effective, with the potential to be used in a wide range of applications where a reliable and efficient source of mechanical motion is required.

The unique air flow system further utilizes a multi-stage process to convert air pressure into mechanical motion. In this system, air is drawn in through the pipe and enters the system through the bottom check valve, which ensures that air can only flow in one direction. Once the air has passed through the check valve, it proceeds through the only open valve in the system and enters the designated chamber. As the air enters the chamber, it has a reverse effect, causing the bottle to raise and become buoyant. This process is the result of the displacement of air within the bottle, as the incoming air needs to fill the space in the chamber and thereby reduces the pressure within the bottle. In this system, air is initially drawn into one of the bottles, causing it to fall as the air is displaced by the incoming air. Once the air has entered the first bottle and caused it to fall, the air in the other bottle is then drawn into the system through the other pipe. This process is achieved by carefully controlling the flow of air and utilizing the pressure differentials between the two bottles.

The unique air flow system further involves air gauge for chambers as shown in FIG. 1e, which involves the use of chambers and tee pipes to control the flow of air pressure. Attached to each chamber is a straw, which is connected to the tee pipe and includes a peg in it. The peg is designed to be nominally smaller than the straw, creating an airtight seal that ensures the flow of air pressure is carefully controlled and regulated. This innovative design provides a reliable and efficient method for converting air pressure into mechanical motion, with precise control over the flow of air throughout the system. The system further utilizes a rigidly attached orange peg and a black rod to control the movement of a green pointer. The black rod acts as a slot joint on the green pointer, allowing for precise control over the movement of the pointer. As the orange peg moves downward, it pulls the back of the green pointer down, causing the other end of the pointer to raise and point to a specific location or object. This movement is achieved through the careful coordination of the orange peg, black rod, and green pointer, which work together to create a highly efficient and reliable mechanism for controlling the movement of the pointer. The system further utilizes springs and a black bar to control the movement of a green pointer. The system includes springs on both the top and bottom, and the black bar can either compress the spring or extend it depending on the pressure in the chamber. When there is no pressure in the chamber, the green pointer will be in the middle. As pressure builds up in the chamber, the black bar will compress the spring, causing the green pointer to move to one side. Conversely, when pressure is released from the chamber, the black bar will extend the spring, causing the green pointer to move to the other side. The system is designed to detect changes in pressure due to a range of factors, including instances where a bottle cannot move up or down due to excessive load. When pressure builds up in the chamber, for whatever reason, the pressure gauge system responds by indicating the change in pressure. In cases where air is being sucked into the chamber but cannot do work on the bottle due to a high load, the pressure gauge system activates an orange rod which then moves the pointer upward, indicating a low-pressure event. Conversely, when there is positive pressure in the chamber, the system is designed to detect this pressure and respond by pushing the rod upward, causing the pointer to move downward, indicating a build-up of pressure in the chamber.

As described above, the system utilizes the peag that is a hollow peg with a capped top to control pressure release. The system is designed to detect high pressure conditions and respond by releasing the excess pressure through the hollow peg. The peg is carefully designed to be hollow, with a capped top that serves as a pressure relief valve. When pressure builds up in the chamber and pushes the orange rod up, the pressure is eventually released through the hollow peg as the excess pressure causes the capped top to open and allow the pressure to escape. The system further utilizes strategically placed holes to regulate air pressure within a chamber. The system is designed to detect low pressure conditions and respond by allowing air to enter the chamber through the holes. The holes are located at the top of the chamber and are carefully positioned to ensure that they are lower than the straw when the orange peg is pulled down due to low pressure. This allows air to be sucked in through the holes and travel through the straw, thereby equalizing the pressure within the chamber.

The system further utilizes the pressure sensing device on both sides of a chamber, with a pointer that works equally for either side. The system is designed to detect large pressure spikes in either chamber or indicate an imbalance if one occurs. The pressure sensing device is carefully designed to provide precise and accurate measurements of pressure changes within each chamber. The pointer is attached to the pressure sensing device and can indicate an imbalance in pressure if a large spike occurs in either chamber.

The present invention further discloses an innovative pressure gauge system that provides precise indication of pressure variations in a chamber. The system is designed to detect changes in pressure due to a range of factors, including instances where a bottle cannot move up or down due to excessive load. When pressure builds up in the chamber, the pressure gauge provides a visual display of the increase in pressure. In cases where air is being sucked into the chamber but cannot do work on the bottle, the pressure gauge responds by activating an orange rod which in turn moves the pointer upward, indicating a low-pressure event.

The present invention relates to a novel air pressure conversion system that can convert both positive and negative air pressure into a reciprocating motion. This reciprocating motion is then cleverly transmitted through a sophisticated mechanism, ultimately resulting in the turning of a shaft in a single, consistent direction. The innovative system described in this patent provides an unparalleled level of versatility and efficiency, making it ideal for use in a range of applications, from industrial machinery to consumer appliances. With the ability to capture and convert any form of air pressure, this invention is a significant step forward in air pressure technology, offering superior performance and reliability over traditional systems. The conversion system of this invention uses a unique reciprocal motion mechanism to effectively harness the energy of air pressure, regardless of its type or magnitude. This results in an energy-efficient conversion process that maximizes the utilization of the available energy to generate powerful mechanical motion in the shaft. In summary, the air pressure conversion system described in this patent represents a significant advancement in air pressure technology, offering an innovative and versatile solution that is poised to revolutionize the way air pressure is harnessed and utilized in a range of industrial and consumer applications.

Advantages of the described invention could include:
1. Versatility: The invention can utilize any type of air pressure, positive or negative, to generate a reciprocal motion and drive a shaft in a single direction.
2. Efficiency: The system is designed to use the available air pressure in the most efficient manner, thereby reducing waste and increasing productivity.
3. Precision: The system includes a pressure gauge and pointer that can accurately indicate pressure levels within each chamber, allowing for precise pressure regulation.
4. Reliability: The system is designed to respond quickly to changes in pressure and regulate pressure levels within each chamber, ensuring consistent and reliable performance
5. Safety: The system includes a pressure gauge and safety features, such as holes and a capped peg, to prevent pressure buildup and ensure safe operation.
6. Cost-effectiveness: The invention is designed to be simple and cost-effective, reducing the need for complex and expensive components.
7. Compatibility: The invention can be used in a variety of industrial and consumer applications, making it a versatile and adaptable solution for a range of needs.

Overall, the described invention has the potential to offer a range of advantages, including increased efficiency, precision, and safety, as well as cost-effectiveness and compatibility with a variety of applications. Thus, the present invention is well adapted to carry out the objects and attain the ends and advantages mentioned as well as those inherent therein. While preferred embodiments of the present invention have been illustrated for the purpose of the present disclosure, changes in the arrangement and construction of parts and the performance of steps can be made by those skilled in the art, which changes are encompassed within the scope and spirit of the present invention as defined by the appended claims. Although embodiments of the present invention have been described in detail for purposes of illustration, various modifications and enhancements may be made without departing from the spirit and scope of the present invention.

What is claimed is:

1. A system for utilizing air pressure to generate a reciprocal motion and drive a shaft in a single direction, comprising:
two chambers, each having a bottle that is moved either upward or downward by the air pressure within the chamber;
a series of valves, check valves, and pipes for the air to flow through to move from one chamber to the other and create a cyclical process of air movement;
a pressure gauge attached to each chamber and a pointer that indicates any imbalances in pressure within each chamber; and
a peg attached to a straw within each chamber, creating an airtight seal that allows air to be sucked in or released through holes or the capped end of the peg.

2. The system of claim 1, wherein the pressure gauge and pointer are designed to work equally for either chamber, ensuring that any imbalances in pressure are quickly detected.

3. The system of claim 1, further comprising safety features to prevent pressure buildup and ensure safe operation, including holes and a capped peg to release pressure and prevent excessive pressure within each chamber.

4. The system of claim 1, wherein the peg within each chamber is adjustable in size to vary the air tightness of the seal and thereby control the amount of air that can be released or sucked into each chamber.

5. The system of claim 1, wherein the pressure gauge is connected to a control system that can automatically adjust the air flow and pressure within each chamber based on pre-determined settings.
